(19) United States
(12) Patent Application Publication
(10) Pub. No.: US 2025/0350349 A1
(43) Pub. Date: Nov. 13, 2025

(54) INSTALLATION FOR A WIRELESS COMMUNICATIONS SYSTEM WITH EDGE COMPUTING

(71) Applicant: Tethercells Limited, Cambridge (GB)

(72) Inventors: Peter Davidson, Douglas (IM); Andrew Faulkner, Cambridge (GB)

(21) Appl. No.: 18/868,913

(22) PCT Filed: May 19, 2023
(86) PCT No.: PCT/GB2023/051320

§ 371 Date: Nov. 25, 2024

(30) Foreign Application Priority Data
May 25, 2022 (GB) 2207627.7

(51) Int. Cl. H04B 7/185; H04B 1/40

(52) U.S. Cl. CPC H04B 7/18517; H04B 1/40

(57) ABSTRACT

An installation for a wireless communication system, comprising a radio frequency transceiver, for providing wireless communications to user equipment located within a wireless communication area, the transceiver being coupled to a communications signal processing facility, and comprising a data link to a wider communication network, the installation further comprising: a ground-based location comprising: an edge computing facility, the computing facility comprising a data link to a cloud computing network, and comprising data storage, processing and networking capability, and linked to the communications signal processing facility; and a source of electrical power; an elevated location comprising: an aerostat comprising the radio frequency transceiver, the aerostat being tethered to the ground-based location, wherein the tether comprises a data connection between the ground-based location and the radio frequency transceiver, and a power cable for providing electrical power from the source of electrical power to the radio frequency transceiver.

### TECHNICAL FIELD

The present invention relates to an installation for a wireless communication system, comprising a radio frequency transceiver, for providing wireless communications to user equipment located within a wireless communication area, comprising an edge computing facility, the installation being capable of delivering wireless communication services over a wide area.

### BACKGROUND TO THE INVENTION

Mobile communications is a major industry, driven by a strong desire to communicate from anywhere at any time. Cellular communications systems were introduced in the 1980's to cover geographical areas with multiple areas, or “cells”. Users have unique connections by separation in bandwidth and time slicing within each cell. Since its inception the mobile industry has grown very substantially with numerous technical evolutions that have improved communications performance dramatically from the early systems. The capability of the cellular system was initially simple analogue based telephony; cellular networks are now at the stage where most computing functions are available due to the high communication data rates and data volumes available to the mobile User Equipment (UE). This enables not only audio communications, but video communications, email, web browsing and many applications ranging from remote booking and ordering systems through to health monitoring. The cellular system capabilities are now supporting the “Internet of Things” (IoT) where control and monitoring can be applied to a myriad of applications which do not need any immediate human interaction. The capabilities of cellular systems continue to improve using integration with advances in processing networks: cloud computing and more recently so-called ‘edge computing,’ whereby applications requiring substantial processing and communication, with low-latency and very fast response, are supported by local networked processing facilities installed close to cellular base stations.

All the benefits of the cellular and a fully connected environment for UE's are, of course, only available where there is reliable, high quality, high data rate, communications coverage. This is generally already available in urban centres, but coverage for other areas, especially rural, can be patchy or non-existent. This is a severe limitation, not only for people that live in these areas, but also for people travelling through them, as well as for industries that are remote or dispersed: e.g. health provision, hospitality, agriculture, forestry, water supply etc. It is also the case that, even in urban areas, there are many districts with poor coverage, often due to a lack of mobile phone masts caused by the difficulty of obtaining planning permission, and shadowing from buildings and vegetation etc.

The more recent opportunities of using edge computing are set to provide dramatic enhancements for existing and new industries if the communications network can provide economic low latency, high reliability, high data, rate ubiquitous coverage. Relief for the wider data network from delivering large quantities of data, which is expensive and power consumptive, is also desirable. Many applications will be developed in the near term, e.g. virtual and augmented reality systems, leading to a wide implementation of the “Metaverse”, enhanced safety for autonomous vehicles, and delivering access to resources for the IoT used in rural areas: health provision, farm automation and control, natural resources monitoring etc., which will need these coverage and large data requirements to be addressed.

U.S. Pat. No. 11,019,491 B2 discloses the use of edge computing in the context of a 5G wireless communication network.

S. Wang et al., “Federated Learning for task and Resource Allocation in Wireless High-Altitude Balloon Networks”, IEEE Internet of Things Journal, vol. 8, no. 24, pp 17475, 2021 discloses a system based on high altitude balloons free flying in the stratosphere to reduce latency and power requirements of communicating to the ground, with an edge computer system carried on the balloons.

KR 102345374 B discloses a ground-based edge processing system with enhanced links via unmanned aerial vehicles, which may have edge processing on board.

Current cellular networks are mainly implemented with base station antennas using towers typically 15 metres tall or attached to buildings. The distance range of transmissions from this height is severely limited by ground clutter: buildings, trees, hills etc. Such clutter often limits the size of the cells formed to a few kilometres radius. The consequence for delivering coverage over large geographic areas is that there needs to be a very large number of towers built, typically many tens of thousands across a country. This is expensive to provide, especially in lightly populated remote regions. Also, there is often considerable difficulty in obtaining access to all the land required and obtaining planning permissions, or indeed to gain access to desirable sites which allow coverage of particular areas. For example, access to buildings around historic city centres or hills providing good line of sight may be restricted commercially or by virtue of planning constraints.

There is a further issue with having a very large number of base station sites; with the implementation of dispersed cloud computing coverage to be made available at the “edge” of a cellular network (i.e. “edge” computing) there are necessarily either a very large number of sites, with the consequent cost and maintenance issues of having an edge computer at each site, or the base stations need to be aggregated into clusters with low latency direct interconnects to limit the number of edge processing sites. This, in turn, is not only costly and inconvenient but also increases response latency—a key benefit needed for many applications that use edge computing on the latest generation of cellular network protocols.

A satellite system is relatively distant from ground-based UE, being at an altitude of hundreds of kilometres, usually over 500 km for LEO satellites. This altitude makes it very difficult to provide small cells on the ground, particularly at normal mobile phone frequencies of less than 6 GHz. While there are satellites communicating directly with portable terminals at relatively low frequencies, these are specialist units and have restricted data rates; the satellites delivering wide bandwidths typically operate at frequencies of 12 GHz and higher and usually carry high-gain antennas. Even at these high frequencies and using high gain antennas, the beam widths formed cover very large areas, limiting the shared data rates available for individual UEs if the density of users is more than a few people per square kilometre. The result is that relatively large, directional ground antennas are required to communicate at high data rates with the satellites. This arrangement works for fixed or vehicle based ground stations, but is not feasible for standard mobile UEs. The role of a satellite system for high speed data is in providing wide geographic coverage, ideally with a relatively low concentration of users, for backhaul or fixed line replacement.

There is the prospect of providing a communications service to smartphone UEs using links to aircraft flying in the stratosphere. A fully commercial service has not yet been proven, although there are serious developments in progress. An airborne system can provide cell sizes equivalent to normal terrestrial towers and be capable of delivering a service at sub-6 GHZ frequencies to normal UEs. These systems also need high speed backhaul links to connect to the cellular system core, which may be provided with ground-stations at convenient locations. The use of aircraft incurs system capital and operational cost penalties, with energy generation needed to power the aircraft and the communications system remotely, airports to operate from and flight planning to deliver the aircraft to operating locations. These systems are good for deployment over remote areas, providing alternative backup for terrestrial systems and swift deployment in locations requiring temporary coverage, e.g. major events or natural disasters. They provide a potential complementary role to the invention.

Thus, communications systems at increased altitude for enhanced coverage is currently provided by satellite systems, ideally operating in low earth orbit (LEO) and planned for aircraft operating in the stratosphere. However, both these approaches limit the performance delivered for a mobile cellular system.

### SUMMARY OF THE INVENTION

In a first aspect, the invention relates to an installation for a wireless communication system, comprising a radio frequency transceiver, for providing wireless communications to user equipment located within a wireless communication area, the transceiver being coupled to a communications signal processing facility, and comprising a data link to a wider communication network, the installation further comprising: a ground-based location comprising an edge computing facility, the computing facility comprising a data link to a cloud computing network, and comprising data storage, processing and networking capability, and linked to the communications signal processing facility, and a source of electrical power; an elevated location comprising an aerostat comprising the radio frequency transceiver, the aerostat being tethered to the ground-based location, wherein the tether comprises a data connection between the ground-based location and the radio frequency transceiver, and a power cable for providing electrical power from the source of electrical power to the radio frequency transceiver.

By locating the transceiver at an elevated location, the invention allows a very high geographical coverage for cellular communications and therefore provides coverage over a wider area with fewer base stations, which, due to their innovative nature, are termed ‘installations’ in the context of the present invention, effectively providing the benefits of low latency ‘edge computing.’

Edge computing is a distributed computing model that brings computation and data storage closer to the sources of data. It is not the actual user device, which may be a smart phone or IoT device, but is the computer and data storage system, which is being used for data processing. The benefits are low latency, since there is limited distance for the requests to travel and locality, which may be important for some security or privacy reasons. Edge computing is part of a larger network of cloud processing using computer systems at multiple locations. There are often very large centralised computing facilities operating as the main networked resources with associated computers physically at the edge delivering localised low latency services. The cloud processing could also be more homogeneous with multiple edge computers linked in a network each delivering localised services and also cooperating to deliver a large computing resource. As part of an overall cloud network the benefits of consolidated resources include, e.g., computing capacity, data storage, security systems and locality of an edge computer with low latency and reduced wide area network data traffic. Edge computing, especially connected to a wireless network such as 5G delivering major benefits, is a major focus for the computing industry as the next paradigm shift in computing.

Data processing and storage is performed on the edge computer for data exchanged over the wireless communications links. For example, the edge computer may carry out local processing for applications to be delivered via the transceiver to user equipment, e.g. augmented reality, virtual reality, IoT, etc.

The basis of the invention is to provide a service to a large geographic coverage area using a limited number of installations, compared with what would be required for conventional low elevation towers for conventional base stations. Each installation operates a transceiver, such as an appropriate antenna, from an elevated location, suitably interfaced to a communications core network via appropriate signal processing, from a tethered aerostat.

Having fewer installations for a given geographical coverage has a number of significant advantages. For example, planning and other restrictions are mitigated by reducing the number of installations required. Also each installation can have more edge processing capability for a given economic constraint, providing greater computing and communication resources for a given cost.

Preferably the elevated location is from 100 m to 10,000 m, preferably from 200 m to 5,000 m, more preferably from 400 m to 3,000 m above ground level. This high elevation can gives very extended coverage of tens of kilometres from the installation. At elevations of between 300 m and 2000 m, then an entire country of 250,000 km² can be covered with around 100 to 300 installations.

Thus, preferably the wireless communication area is greater than 500 km², preferably greater than 1000 km², more preferably greater than 5000 km².

Each installation may be arranged to form a pattern of beams over a large area, which can provide communication cells. Thus, preferably the wireless communication area is divided into a plurality of cellular communication cells, preferably at least five, more preferably at least ten, more preferably at least twenty, most preferably at least forty, e.g. about one hundred.

By providing a large coverage area delivering many individual cells from an installation there is a substantial concentration of resources compared to a conventional tower based implementation. This makes the installation of significant cloud edge computing capability very cost and performance effective. The minimal communication equipment and data links in the path from the UE to the edge processing provides both low latency and high availability.

Thus, preferably the edge computing facility has a processing capability of greater than 10¹² Flops, preferably greater than 10¹³ Flops, more preferably greater than 10¹⁴ Flops or even greater than 10¹⁵ Flops. Additionally, the maximum data transfer latency between user equipment and the edge computing facility is preferably less than 5 ms. The edge computing facility is capable of providing a range of low latency computing intensive applications, such as 3^{rd} party applications such as internet of things, video processing, driverless cars etc.

The edge computing facility will comprise at least one edge computer, wherein each edge computer is typically made up of at least one server, preferably a cluster of servers, and can optionally have its own independent data link to a specific cloud computing network.

The ability to deliver low latency services requires cellular protocols to be able to define specific quality of service requirements to identified users or groups. This may be achieved using “network slicing” to prioritise some users over others to ensure their service level agreement, SLA, is met. This can prioritise latency, cost, data volume, privacy etc. In the performance of the edge computer, latency can also be subject to SLAs which prioritise some users (who may be paying for specific performance) over others who have not agreed to the commercial requirements. This enables limited communications resources to be utilised most effectively.

The invention can thus deliver high performance cloud edge computing and economical cellular and fixed wireless communications over a large geographical area, with networked processing facilities located at a substantially ground level, close to the aerostat tether, so as to provide low latency between the networked processing facilities and the user equipment.

In a preferred embodiment the cloud computing network comprises a major commercial (typically private) cloud computing network (e.g. Azure™, Amazon™, Google™). These systems provide the networking structure to support the applications that run on the cloud, as well as the extreme levels of data security essential to safeguard the data used on the cloud network. The edge computing facility can therefore draw on the resources of a specific cloud supplier. Direct interfacing with the cloud system delivers the lowest latency services.

The edge computing facility may comprise a plurality of edge computers, allowing each edge computer to be independently connected to a different cloud computing network. Alternative commercial cloud suppliers can thus each install a second, third or fourth etc, edge computer at the installation and benefit from the same direct connection, lowest latency services.

It can be seen that there are significant benefits to a cloud based supplier installing an edge computer as part of their network at the installation site.

Alternatively, the cloud computing facility may be provided by a network of other edge computing facilities in a number of networked installations according to the invention, in a wireless communications system as discussed below.

The edge computing facility may be located physically close to the point where the tether meets the ground-based location. The edge computing facility is typically connected thereto with a low latency link.

By “physically close” is meant less than 1 km, preferably less than 100 m, more preferably less than 10 m.

The communications signal processing facility manages all aspects of the RF communications with user equipment such as protocol, resource sharing and identification of user equipment. In one possible arrangement, the communications signal processing facility is provided by bespoke wireless signal processing hardware, such as is employed in base stations known in the prior art. In this embodiment the edge computing facility may be a separate piece of hardware, but having a data link thereto. Locating the signal processing hardware at the ground-level location minimises the mass needed to be supported by the aerostat. In this case, it is preferred that the edge computing facility is located physically close to the bespoke wireless signal processing hardware.

A further benefit of edge computing is for the processing of the communications system itself. The core of the communications signal processing is typically implemented as software systems on a wider communication network to a large cloud computing facility or facilities. However, almost all cellular networks deployed use special purpose signal processing systems, such as the Radio Access Networks, (RANs) at the base stations with bespoke hardware. These process the complex and high speed protocol management of the cellular network, which is essential to deliver high performance for the users.

However, use of bespoke hardware inhibits competition and innovation by restricting availability to a few dominant companies. However, with the increased performance available from standard computing servers and networks there is an opportunity to implement these signal processing systems as software applications on conventional computing platforms.

Therefore, in another embodiment, the edge computing facility may be arranged to carry out some or all of the communications signal processing, e.g. by integrating the cellular RAN components into the edge computing facility in software. This provides the advantage that no bespoke wireless signal processing hardware may be necessary. Typically, this will all be carried out at the ground-level location, however it is conceivable that some communication signal processing is carried out at the elevated location, e.g. on a computer with software-based RAN.

The edge computer may also be used to provide core access network functions for communicating between users of the installation. This may be achieved by having access network core function onto the edge computer as a standalone system, providing connectivity and computing only over the wireless communication area.

An edge computer may therefore provide a distributed element of the “core” of a cellular network at an installation, especially with a software-based RAN. This enables communications that are made that fall completely within the communication area of the installation to be routed entirely within the installation, thus reducing wide area network data traffic e.g. to merely reporting control information to the rest of the network, enabling large areas to operate without substantial recourse to the remote core, delivering greater robustness in operation.

The installation may even carry out a fully devolved cellular core and local edge cloud computing functions to provide a complete service, which may be especially useful in remote and less developed regions, where there are currently no cellular services or even power provision, when equipped with an edge computer providing the cellular network function of RAN and cellular core. However, unless the system is completely autonomous, even in this instance there will be a requirement for some minimal data to be communicated to the wider communication network, if only to register the existence of a service being carried out. The communications signal processing facility is, therefore, typically connected back to a wider communication network, i.e. the cellular core, e.g. over high speed data fibres.

Access to alternative computer networks may be achieved over the Internet, as determined by the applications running on the edge cloud network installed. Access to alternative networks will necessarily have more extended, and indeterminate latency by being routed through the edge computer to be transmitted over a longer range to an alternative supplier cloud location. Alternatively, other cloud suppliers can be routed through the cellular core as a conventional, non-edge based, system.

Wide area communications, which are minimised by the use of edge computing, can be provided by using a satellite link, linking the installation to a major cloud computing centre that is remote from the installation: the data traffic on the satellite link is minimised due to the facilities and capabilities of the installation.

Power and data is supplied along the tether restraining the aerostat. This approach solves substantial issues that exist for “disconnected” high altitude solutions, which often need to provide considerable power at altitude by solar cells or fuel cells/combustors and have “backhaul” communications via wireless links to link to the communication and computing core, which restricts power availability and total data rates.

Power may be delivered from a suitable power source e.g. grid, solar etc. to the ground-based location, typically using an uninterruptible power system or battery to ensure continuity of supply.

The installation can be made autonomous without recourse to national power, fibre optic or ground based microwave links. Preferably the source of electrical energy is a standalone energy generator, and preferably comprises a solar and/or wind energy generator.

The invention is particularly useful in remote or less-developed regions, where access to cellular communications is very valuable, as well as access to considerable computing resources on the edge computing facility. The UE can be a low cost smart phone, which is readily rechargeable by a solar charger. Sophisticated programmes running on the edge computer can provide information, which is presently unavailable, on many important subjects e.g. health, agriculture, construction etc.

Typically, the ground-based location will comprise a winch, or other winding mechanism for winding in and out the tether, as required.

The aerostat may also comprise additional communications equipment to support the transceiver, such as power conditioning and distribution, data switching for positional control etc. Such supporting equipment including the transceiver is referred to herein as the payload.

Thus, in a preferred embodiment, an installation of the invention consists of an aerostat typically carrying a substantial communications payload and ground-based equipment supplying power, control and communications systems to interface to the communications network core and an edge computing facility. The aerostat is restrained by a tether linked to a winding mechanism to control its altitude and to bring it to the ground for maintenance. The ground equipment, including edge processors, are housed locally in a “cabin” either at the base of the tether or within a short distance from it.

Data fibres for linking the communications payload to the ground equipment, power for the payload and aerostat monitoring equipment, and lightning conductors from the ground to the aerostat are preferably integrated with the tether or can use some other means of connection.

The transceiver, e.g. an antenna, delivers the air interface to user equipment through radio frequency transmitters and receivers. These can be implemented in various ways. A preferred approach, is to use a large phased array with substantial digital beamforming in order to form many separate beams which can be steered with precision to maintain beams at a constant location on the ground while the aerostat moves. The beamforming calculations and processing may be carried out either at the elevated location or at the ground-level location.

When the transceiver is a phased array antenna, it is preferably configured to be cylindrical with its central axis vertically oriented, with antenna elements distributed around the cylindrical outer surface. The cylindrical phased array antenna preferably has a length greater than its diameter to give beams a small radial beamwidth. Thus, preferably the ratio of the length to the diameter of the cylinder is greater than 2.0, preferably greater than 5.0, for example around 10.0. By making the phased array antenna a circular cylinder, the beamshape does not change as the payload rotates and the array tracks location. Hence, the signal processing can maintain location and beam pattern accounting for movement of the payload due to changing wind direction.

If the transceiver comprises a phased array antenna then this will require specific transceiver processing, related to the formation of the beams, also referred to as beamforming calculations, and being in addition to the communications signal processing. Such calculations are typically at least partially carried out at the elevated location, and usually with some carried out at the ground-based location.

Individual RF beams from an installation can be placed anywhere around the antenna up to a range determined by the elevated location and size of the phased array. Typically these can have a range of 30 km or up to 90 km from the installation. The height of the antenna enables the narrow beams to come close to the horizon for the longest range, with a beam angle of preferably within 2 degrees down from the horizontal. The design of the antenna enables the formation of many RF beams, each of which can be used to form individual cells for the cellular network. Each beam can be electronically steered to a desired location. A pattern of beams (cells) can be used to provide complete coverage over a large area around the installation using optimally placed beams—an important aspect is that the beams are relatively small compared to the area covered, limiting the number of users in each cell, thus providing more data capability to each user. Use of a fully controllable phased array means that the location of the beams on the ground can be kept constant, despite inevitable movements and rotations of the transceiver.

The area of the phased array antenna normal to the beam determines the overall area of the beam and therefore ground coverage in a specific direction. It is clearly better to have a large payload to have small cells projected. Also, the sensitivity of the payload increases with size. However, the performance of the phased array antenna requires its length (height) to be maximised, in order to limit the radial extent of the outer beams, which needs many antenna elements to be incorporated. As those skilled in the art of phased array design are aware, spacing antenna elements too far apart will introduce undesirable “grating” lobes which would disrupt the proper performance of the array. A technique of introducing two stages of beamforming can substantially reduce the signal processing requirements for beamforming calculations, by using fixed analogue beamforming as a “composite” antenna element and suppress unwanted grating lobes, which then can maintain performance within limits of scan angle with zero degrees being normal to the array to a limit, for example, of 15 degrees maximum.

Preferably therefore, the phased array elements are composed of multiple antenna elements and a composite element, which are phased together in the analogue domain. Preferably the elements are phased together using fixed amplitude and phase. Preferably the composite elements are arranged in a chequerboard layout, enabling the accommodation of long composite elements, and a further reduction in the number of active composite elements used.

In order for effective communications to be established, the transceiver should be kept in a stable orientation so that the invention can provide beams, used as cells, that are stable in location and size on the ground. However, naturally, the transceiver being at the elevated location, is expected to move around and not be fixed geographically. However, the communications system needs to be aware and determine the location of the cells. Also, if the cells move around then it may be necessary for many UE to change to the adjacent cell, which could all happen at once leading to high network control activity to implement.

The aerostat will inherently change location with wind direction, and will always be substantially downwind from the base of the tether. Thus, wind changing direction, say from south to west, would move the aerostat a quarter of a circle around the winch, where the radius is the projection of the tether onto the ground. If, for simplicity, the aerostat is 1000 m above ground level and the tether is at 45° to the horizontal then the projection of the tether onto the ground is also 1000 m from the winch. Hence moving through 90° from wind direction would result in an aerostat movement of ˜1.4 km. The transceiver would also have a rotation of 90°. This will however, probably be a slow transition from seconds to minutes, due to the mass of the aerostat system and wind change time.

The altitude of the aerostat will also vary somewhat due to varying wind strength. The aerostat can attempt to counter this by balancing drag variations with lift from a suitably placed aerofoil.

The aerostat may also pitch forward and back, or side to side due to turbulent wind or some undesirable aerodynamic instability of the aerostat. These could alter the orientation of the transceiver, also causing movement of the beams on the ground. The period of this is likely to be a few seconds, depending on the design of the aerostat.

Additionally, the aerostat could rotate due to turbulent wind or instability. This would cause all the beams to rotate about the transceiver. The period of this is likely to be fastest due to having the lowest moment of inertia, for example, a large fraction of second to low seconds.

All these instabilities would need to be managed to maintain the integrity of the beam pattern on the ground. The location and orientation of the aerostat can therefore be continuously monitored and reported to an antenna control system, whereby the direction of the beams relative to the transceiver can be moved to keep them stable on the ground. Preferably therefore, the ground-based location comprises aerostat monitoring equipment.

Ideally, the aerostat is of a design that minimises the sources of instability, minimising the need for corrective action. In a preferred embodiment the aerostat is an elongate aerostat that is vertically oriented, in a form of a “vertically buoyant wing”, and preferably for all-weather operation at the installation. There are significant advantages to such a design, particularly with regard to stability.

Further stability is derived mechanically with the mounting of the transceiver. In a preferred embodiment, the transceiver is mounted inside the aerostat envelope. By simply hanging the aerostat under gravity within the envelope the transceiver is protected from the weather and most of the pitch and roll of the aerostat-its movement is heavily decoupled and will be damped. It probably does not protect from yaw, since that movement is rotational-however, even that could be mechanically decoupled at higher frequencies. The mounting is preferably passive, although it could be active with a motorised gimbal.

Electronic stability can also be employed by measuring the exact location and orientation of the transceiver and adjusting the beams to maintain their locations on the ground. This is especially useful for the gross movement due to wind, location over ground and altitude. It will also take out any residual transceiver orientation issues, up to the limit discussed above-even then it does not fail catastrophically but merely progressively degrades, briefly, during the extreme orientation movements.

As noted above, the transceiver can rotate due to changing wind direction and yaw. This is a further reason why a cylindrical transceiver is advantageous, the beamforming can rotate the beam relative to the transceiver since it is symmetrical in all directions and merely moves the elements being used in the beam formation.

Installations according to the present invention can complement conventional low elevation tower systems. For example in urban areas, conventional mobile phones tower systems (under 30 m in height) are more economic than in rural areas, and in the developed world have already made significant penetration. Installations according to the present invention can provide low latency ubiquitous coverage outside such urban areas. No modifications to existing UE are necessary to allow such UE to work in such a hybrid system: the UE will without additional modification look for the strongest and most resource efficient links in such a hybrid system.

A key aspect of delivering distributed computing of this nature is to have the edge computers networked as part of a large cloud computing infrastructure. Most of the present cloud computing services are very large concentrated computer centres delivering services critical to the modern world. By networking smaller, more local computing systems, so-called “edge computing”, and treating them as part of the larger cloud infrastructure, a much more integrated and capable solution is the result. The topology of the network which interconnects the cloud computing can include a star system where all edge computers link directly back to a major cloud site, or provide a mesh interconnect to reduce overall network traffic, provide processing load balancing and, in this system, minimise latency between installations.

Implementing the cellular communications system on an edge computer cluster at each installation further enhances the integration of cellular and computing services. This integration of cellular systems and computing further simplifies the deployment and maintenance of an aerostat based installation.

Thus, in a second aspect, the invention relates to a wireless communication system, comprising a network of a plurality of installations as described herein, the installations being linked together by data links, providing a networked wireless communication area.

Preferably the data links between the installations comprise a radio frequency data link via the transceivers.

Preferably the wireless communication system comprises at least five installations, more preferably at least ten installations, and wherein the networked wireless communication area is greater than 10,000 km², preferably greater than 20,000 km², most preferably greater than 50,000 km².

### BRIEF DESCRIPTION OF THE DRAWINGS

The invention will now be illustrated, by way of example with reference to the following figures, in which:

FIG. 1 is a schematic representation of an installation according to the invention.

FIG. 1a is a broken perspective view of a phased array transceiver for use in the present invention.

FIG. 1b is an outline view of a “composite” element of the phased array antenna shown in FIG. 1a.

FIG. 1c is a flattened view of the arrangement of the composite elements in the phased array shown in FIG. 1a.

FIG. 2 is a schematic representation of a second installation according to the invention, without the edge computer being shown.

FIG. 3 is beam pattern formable by the phased array transceiver shown in FIG. 1.

FIG. 4 is a schematic representation of the ground-based location of a third installation according to the invention.

FIG. 5 is a schematic representation of the ground-based location of a fourth installation according to the invention.

FIG. 6 is a schematic representation of the installation shown in FIG. 5 linked to a satellite network.

FIG. 7 is a schematic representation of a wireless communication system according to the present invention.

FIG. 8 is a schematic representation of a wireless communication system according to the present invention with a single failed installation.

### DETAILED DESCRIPTION

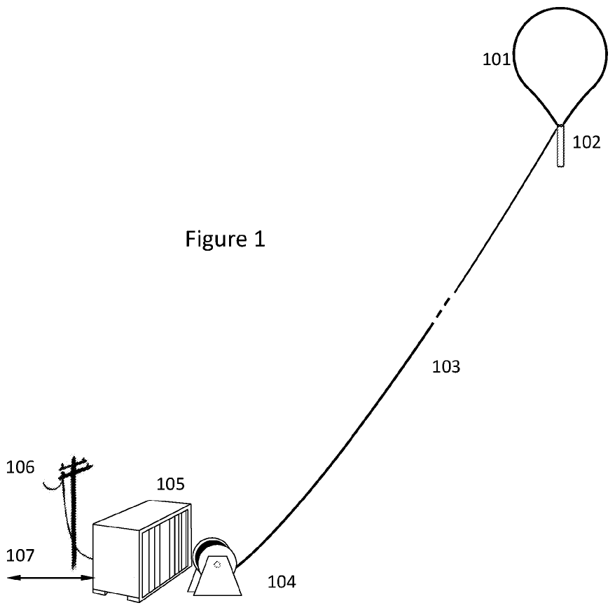

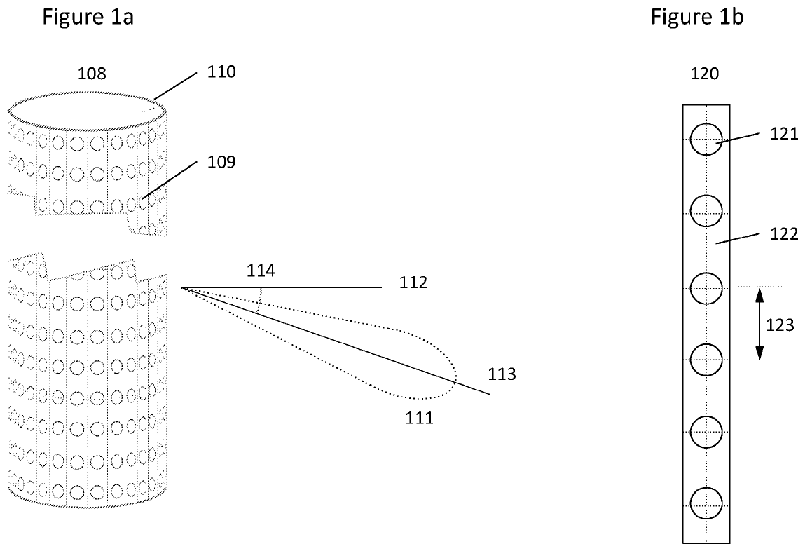

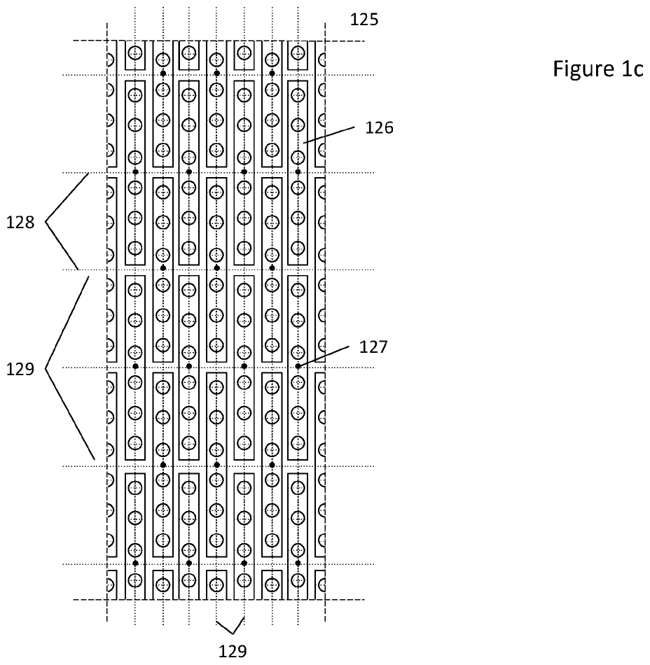

Turning to the figures, FIG. 1 illustrates, in outline, a sample implementation of an installation according to the invention. The system is split into the elevated location with aerostat 101 supporting the payload equipment 102 including the transceiver, and ground-based location consisting of a winching mechanism 104 which connects power and data via the tether 103 to the communications signal processing facility and an edge computing facility housed in a cabin 105. Electrical power 106 and communications links 107, which are typically optical fibre, are provided to the cabin 105. The tether 103 restrains the aerostat 101 and also carries power and data links from the cabin 105 to the payload 102, and provides lightning protection. The equipment necessary to be part of the payload 102 is minimised with as much control and communication processing as practical performed on the ground in the cabin 105 to minimise payload mass.

FIG. 1a shows a phased array transceiver 108, configured as a cylinder evenly covered with antenna elements 109 for use in an installation according to the present invention. The array's circular cross section 110 enables all the beam patterns to be circularly symmetric and ensures that a constant beam shape can be maintained on the ground. The array is very long compared to its diameter, and these proportions form a very elliptical beam 111 that is small in the radial direction, enabling well formed illumination patches on the ground at significant range from the installation.

The beam formed 111, is projected towards the ground in direction 113, which is scanned down from the horizontal 112 at an angle 114. The scan angle 114 available range is from forming a defined patch on the ground at maximum range to a minimum limited by the performance of the array 108.

FIG. 1b shows a “composite” element 120 consisting of a number of individual antenna elements 121, mounted on a substrate 122 and preferably separated 123 by more than half a wavelength to minimise the number of elements. The elements 121 are passively beamformed to form a well-defined composite element beam. The composite element 120 is then treated as an antenna element by the subsequent digital processing. The composite element 120 reduces the total amount of signal processing on a digital array substantially. It is orientated vertically to enable a very tall cylinder. Because the digital beamforming stage now uses widely spaced composite elements then inevitably grating lobes are formed, which are undesirable. However, the beam pattern of the composite element suppresses the grating lobes over a defined scan angle range.

FIG. 1c illustrates a section 125 of the array 108, laid flat for clarity, and the composite elements 126 are wrapped side-by-side around a cylinder. A typical array, as those skilled in the art are aware, is to place elements in a rectangular pattern, however, there is considerable benefit in this application to placing the composite elements 126 as a chequerboard pattern as illustrated. Firstly, this arrangement halves the number of composite elements 126 thus substantially reducing the amount of digital beamforming required. Secondly, the doubled spacing of the vertical pitch 128 enables an increased length 129 of the composite elements 126. This increased length enables an optimised beam pattern for the composite elements 126 which suppresses the undesirable grating lobes due to the vertical pitch 128 being greater than a wavelength. Due to the restricted scan angle range required radially this arrangement minimises the total number of digital processing channels required for the system. The result is that the composite element 126 phase centres 127 are arranged in the chequer board pattern. The phase centre 127 of the composite element 126 is the location where it can be considered to be acting in the overall array 108.

While in this arrangement grating lobes on the horizontal and vertical axes are controlled as if the location matrix was fully filled there are grating lobes formed on diagonal axes. These are controlled by reducing the horizontal pitch 126 from a conventional half wavelength. The result is an array 108 with significant savings in the amount of digital beamforming while minimising the mutual interference caused by grating lobes.

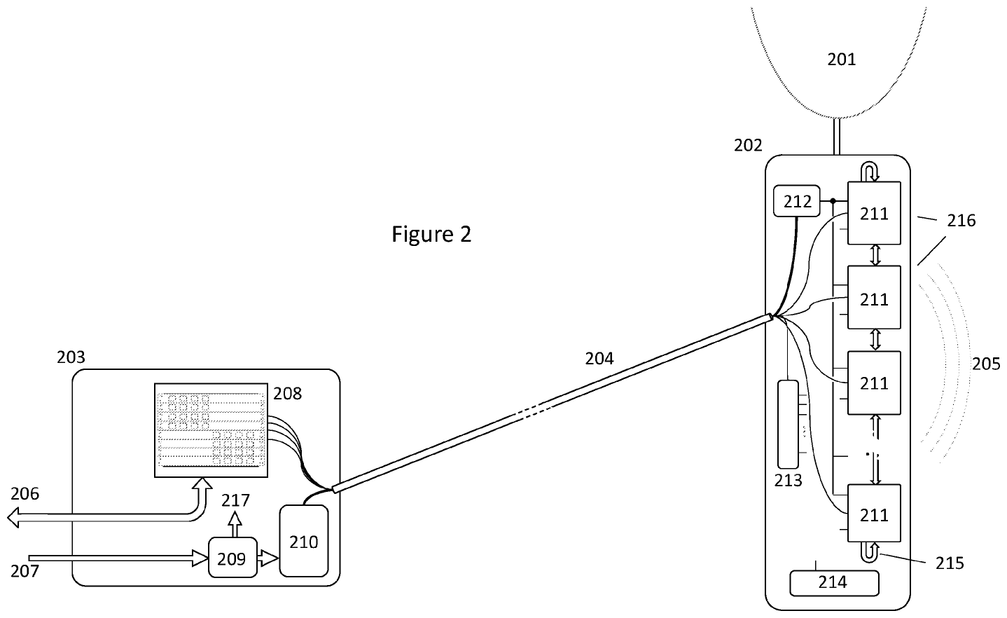

FIG. 2 shows, diagrammatically, a second installation according to the invention, without the edge computer being shown. The aerostat 201 supports the payload 202 comprising the transceiver. The precise orientation of the payload 202 is measured using a position and orientation measurement sub-system 214, this is to ensure correct positioning of the beams on the ground and enabling continuous updating of payload location during changing weather conditions.

The payload 202 houses all the radio frequency, RF, transmission and reception equipment. This could be built with conventional antennas, but in a preferred embodiment, consists of a sophisticated phased array 216 that can form many beams 205 on the ground. The phased array 216 performs all RF transmit and reception functions. The phased array 216 design is preferentially a tall cylinder covered in individual antenna elements. It is tall which enables it to deliver a narrow radial beam, which due to the geometry of beam delivery is important to limit the radial extent of an individual beam. The array 216 is circular to provide an even 360° coverage capability around the Installation. Another important reason is that the aerostat 201 will rotate relative to the ground for different wind directions. A circular profile ensures that the beamshape can remain constant at all times, despite using different antenna elements for different rotations.

The phased array 216 is preferentially longer than its diameter and constructed from individual sections 211. The sections 211 have their data channels connected (“daisy-chained”) using a high speed data link 215. Each individual section 211 is identical, making manufacture efficient. The whole array 216 can be made to a height that is required by adding more sections 211 as required.

Power and data links are provided through the tether 204. Power delivery is terminated and conditioned 212 before being distributed around the payload 202. Control processing for the payload is located in the cabin 203 on the ground and delivered via fibre. This data is then distributed around the payload by a data switch 213.

Beam formation is performed by the payload 202, and the signal data is delivered and received via fibres embedded in the tether 204, which are directly linked to the phased array 216.

On the ground, the cabin 203 houses a bespoke wireless signal processing hardware, including routers and baseband modules 208, i.e. RAN modules. These are replicated sufficiently to support as many beams as formed by the payload 202 and used as individual cells. In this system illustration, the RAN modules 208 are identical or very similar to the units used in conventional tower based systems, highlighting that the Installation is “conventional” as far as the cellular system is implemented. The communication data link to the wider communication network for the installation is linked to the cellular core via fibres 206.

Power is delivered to the installation 207 and is safeguarded using an uninterruptable power supply, UPS, 209. The UPS 209 also distributes power to the ground systems 217 and via a conditioning and isolation system 210 to the payload 202 via the tether 204.

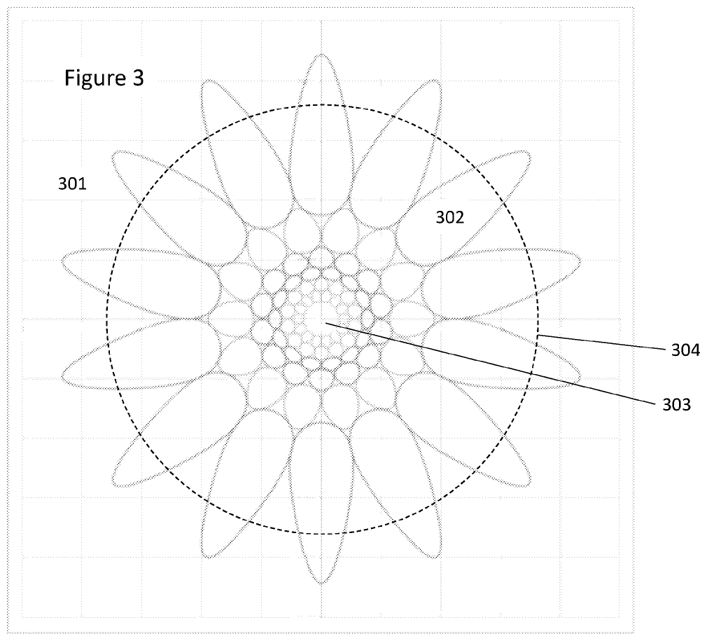

FIG. 3 illustrates a possible beam distribution pattern 301 projected onto the ground. There are multiple beams 302 all around the Installation providing 360° coverage due to having a small radial beamwidth as formed by the payload. There can be multiple concentric beam patterns which deliver increased data density on the ground and higher aggregate data rates to the users. The pattern shown is from an aerostat at 600 m altitude and has a useful range 304 of approximately 35 km from the location of the Installation at 304. This can be varied by altering the altitude of the payload or design of the phased array.

Directly beneath the payload there is an area 303 that does not receive coverage due to the available scan angles from the payload. This region is readily covered by a more conventional array, either flat or preferably hemi-spherical, largely pointing directly down and delivering a conventional pattern of beams to be used as cells.

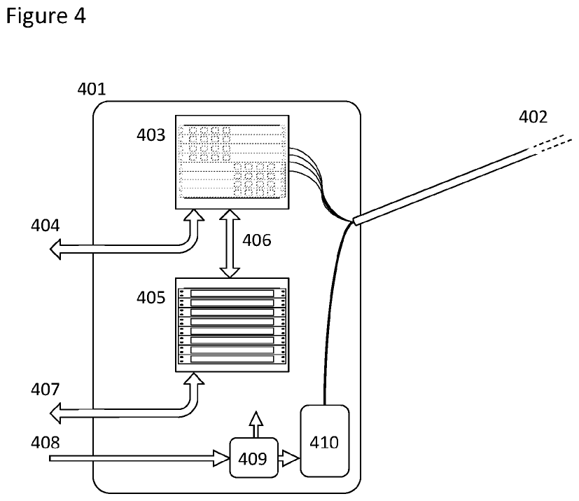

FIG. 4 shows the ground-based location of a third installation according to the invention, showing a ground cabin 401 including an edge computer 405. The elevated location is essentially as illustrated in FIG. 2, The tether 402 linking to the aerostat and payload is unchanged. The bespoke wireless signal processing hardware, i.e. RAN equipment 403 provides cellular communications using data link 404 to a wider communication network, i.e. the cellular core, with an additional data link 406 directly to the edge computer 405. The edge computer 405 connects directly into a cloud computing network via a dedicated fibre link 407. The installation is powered via an incoming electrical power supply 408, with additional support for the edge computer.

It is evident that the data link 406 to the edge computer 405 is very short and delivers minimal data latency. Also it is clear that there is very little equipment between the UE and the edge computer 405. This inherently delivers higher reliability due to reduced opportunity for failure.

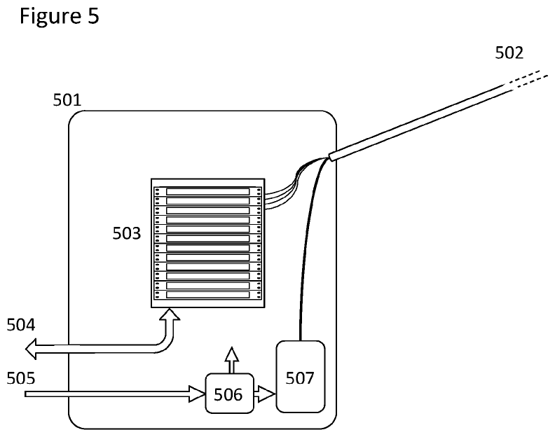

FIG. 5 shows the ground-based location of a fourth installation according to the invention, wherein the communications signal processing facility is provided by the edge computer 503 using software modules to deliver the RAN functionality. This approach delivers identical performance to conventional hardware implementations of the RAN components, with the benefit that running so-called cloud RAN software reduces the amount of specialist hardware, increases flexibility in the functionality of the cloud-RAN modules by enabling conventional software upgradeability and the tight integration of the cellular system with edge processing delivers minimum latency capability.

The edge computer 503 is linked into the wider cloud computing network via fibre links 504. This link also now carries the link to a wider communication network, i.e. all network traffic including the cellular network data to the cellular core, which is a more optimal and flexible implementation than having physically separate data links, as shown in FIG. 4. The cellular core software may advantageously be distributed on the cloud network including the local edge computer 503.

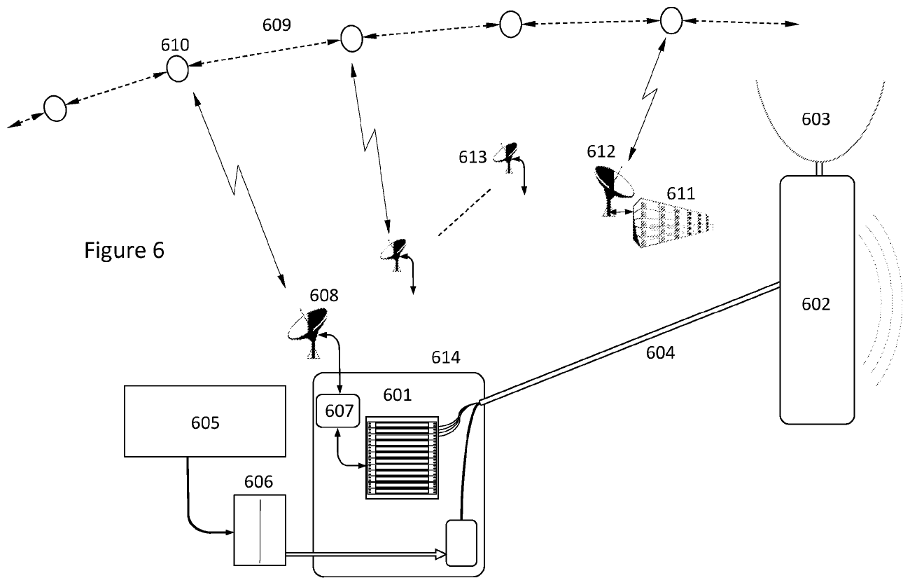

FIG. 6 shows the installation shown in FIG. 5 linked to a satellite network, and configured for remote site operation. This is especially beneficial for a developing country or very remote locations with little or no local infrastructure to support conventional installations with high speed data links or local power.

The installation is configured as illustrated in FIG. 5, with a cabin 614 including an edge computer 601 providing both cellular network and computing resources. This installation may benefit from providing extra wide coverage capability by flying the aerostat at an increased altitude, e.g. 1500 m or 2000 m.

Power is provided locally using renewable energy: wind or more likely solar 605. To ensure continuity of power supply, energy is also stored in an energy storage system 606. The energy then supplies the installation in a conventional manner.

The wide area links to the cloud computing network and to the wider communication network can be via a satellite link 610. A satellite communication interface 607 to a tracking satellite antenna 608. Considerable satellite communication capacity is deployed using large LEO satellite constellations 609. The LEO satellites deliver global coverage and at data rates exceeding 100 Mb/s. Also, with direct satellite links 612 are cloud computing centres 611, the infrastructure to deliver remote operation is developing strongly.

Further remote Installations 613 can be deployed, also using the same architecture.

The backhaul communications are relatively low bandwidth compared to current deployed cellular networks. However, the distributed nature of the cellular core enables all communications entirely within the installation coverage area, which is quite large, to be managed locally and not impact the wide area network. These are the majority of communications made especially among newly connected populations. The Internet traffic, for example transmission of video content from the Worldwide Web, can be mitigated with substantial caching of data locally at the edge computer 601. Consequently, all popular web pages will be locally accessed and again mitigate the data rate required to be transferred from the cloud cluster 611.

The availability of substantial local computing resources being delivered to a population with virtually no data resources will have a major impact on their quality of life. Critical resources such as health analysis and recommendations, agricultural information, weather warning information etc. will become available. The users' smart phones are relatively low cost and can be recharged using solar energy.

An installation of this design can support a substantial population, which for example exceeds the population density of 80% of the geographic area of Africa.

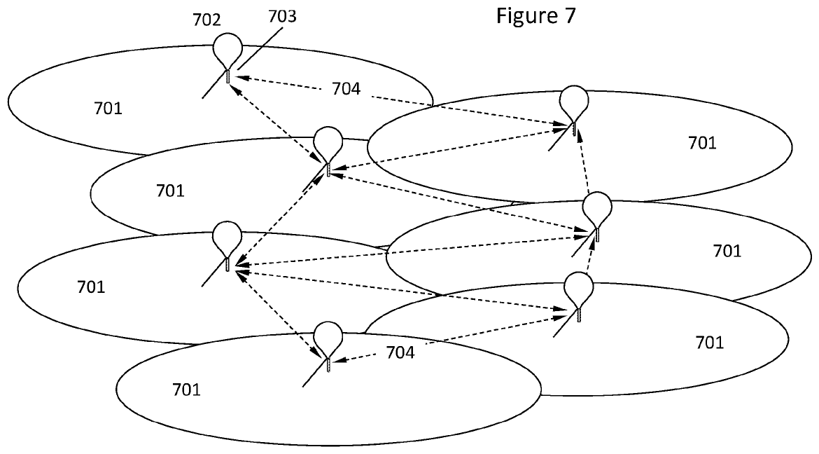

FIG. 7 shows a wireless communication system according to the present invention, a communications “mesh” enhancement to provide direct links between a number of installations used to cover a geographic area. Each aerostat 702 delivers communication services to an area 701. There are benefits, especially when a wide area communication link over fibre is not available, to have adjacent installations 702 to have a connection link 704 between them. The link 704 may be implemented using an RF solution at a chosen frequency and bandwidth or using free space optical links for higher performance. Usage examples include: when there are a number of remote installations that are designed to operate using relatively low bandwidth, satellite links then direct communications with adjacent installations for linking UEs together can reduce the need for satellite traffic; also, in cases when there is a fault on the link to the wide area communications then linking to adjacent installations 702 can provide an effective fall-back service until the link to the wider network is repaired.

If a complete mesh is implemented then each installation 702 may have links 704 adjacent installations which are within range. To further minimise wide area communication data traffic, then the mesh can be used as a multi-hop arrangement to link to installations 702 further than just the adjacent installation. In the case of a remote system using satellite links for wide area networking then the data downloaded from the remote cloud network can be shared amongst multiple edge computing facilities in the installations to enhance the performance of the entire system.

The links 704 will normally be line-of-sight since the payloads 703 are at an altitude that ensures that the horizon does not intercept the link 704. There are options in the technologies that provide the links 704 which trade-off cost, complexity, data rates and mass. A solution using free space optics can be very high bandwidth, but will be difficult to keep in perfect alignment and heavy. In the case of using RF then mmWave links can be used, which are also high bandwidth, but complex to align and heavy. Lower frequency RF is an option which could have reduced mass and simpler alignment issues, but is likely to be a lower data rate due to reduced bandwidth.

In regions with little or no cellular communications or in the case of failed fibre links then there is the option of using some of the bandwidth on the main phased array, so called in-band operation, to operate within the cellular allocated bands, an in-band implementation. The main phased array has been designed to be fully steerable and maintain beam direction. Also there is no mass penalty, since the beams formed would only require a signal processing resource that is already implemented for the payload 703. This is a convenient solution and is a software upgrade on normal systems.

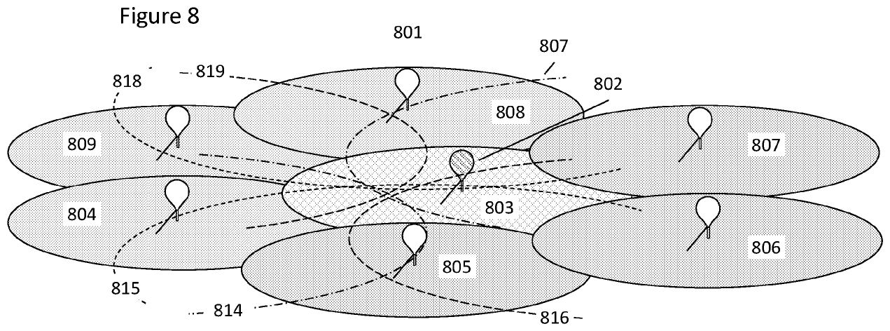

High availability coverage is important over some areas, FIG. 8 shows redundancy planned as part of multiple Installations over a wider geographical area. Seven Installations of the total coverage are shown at 801, with one failed Installation 802 and its associated coverage area 803 plus six surrounding Installations and their normal coverage areas 804-809. All of the Installations do not use the full extent of their geographic coverage capability, but are closer spaced than the maximum range available. This has the benefit that the outer cells are reduced in size, giving an increased spectral density, which is advantageous in relatively high population areas.

When installation 802 fails then the surrounding installations 804-809 can extend their coverage areas 813-819 to include coverage for area 803. Only arcs of the extended coverage areas are shown for clarity. With appropriate planning then loss of installation 802 can be covered with a reduced service until such time as the installation is repaired and normal service capability is resumed. The beams providing the extended service are necessarily larger and hence do not have the spectral density normally provided, however, for periods of planned maintenance which would be at times of low usage or for emergency use then there continues to be service availability. Geographical installation planning can ensure that any failed installation can be covered temporarily.

1. An installation for a wireless communication system, comprising a radio frequency transceiver, for providing wireless communications to user equipment located within a wireless communication area, the transceiver being coupled to a communications signal processing facility, and comprising a data link to a wider communication network, the installation further comprising
a ground-based location comprising:
an edge computing facility, the computing facility comprising a data link to a cloud computing network, and comprising data storage, processing and networking capability, and linked to the communications signal processing facility; and
a source of electrical power;
an elevated location comprising:
an aerostat comprising the radio frequency transceiver, the aerostat being tethered to the ground-based location by a tether, wherein the tether comprises a data connection between the ground-based location and the radio frequency transceiver, and a power cable for providing electrical power from the source of electrical power to the radio frequency transceiver.

2. The installation according to claim 1, wherein the elevated location is from 100 m to 10,000 m, preferably from 200 m to 5,000 m, more preferably from 400 m to 3,000 m above ground level.

3. The installation according to claim 1, wherein the wireless communication area is greater than 500 km², preferably greater than 1000 km², more preferably greater than 5000 km².

4. The installation according to claim 1, wherein the wireless communication area is divided into a plurality of cellular communication cells, preferably at least five, more preferably at least ten, more preferably at least twenty, most preferably at least forty.

5. The installation according to claim 1, wherein the edge computing facility has a processing capability of greater than 10¹² Flops.

6. The installation according to claim 1, wherein the minimum data transfer latency between the user equipment and the edge computing facility is less than 5 ms.

7. The installation according to claim 1, wherein the edge computing facility comprises a plurality of edge computers.

8. The installation according to claim 7, wherein each edge computer has an independent connection to a different cloud computing network.

9. The installation according to claim 1, wherein the cloud computing network comprises a major commercial cloud computing network.

10. The installation according to claim 7, wherein each edge computer is independently connected to a different major commercial cloud computing network.

11. The installation according to claim 1, wherein the communications signal processing facility comprises bespoke wireless signal processing hardware, located at the ground level ground-based location.

12. The installation according to claim 11, wherein the edge computing facility is located physically close to the bespoke wireless signal processing hardware.

13. The installation according to claim 1, wherein the edge computing facility is operable to provide at least a portion of the communications signal processing facility.

14. The installation according to claim 13, wherein the edge computing facility is operable to provide all of the communications signal processing facility, preferably by executing O-RAN software.

15. The installation according to claim 1, wherein the edge computing facility is operable to provide core access network functions for communicating between users of the installation.

16. The installation according to claim 1, wherein the edge computing facility comprises a data link to the Internet.

17. The installation according to claim 1, wherein the installation comprises a satellite data link.

18. The installation according to claim 1, wherein the source of electrical energy power is a standalone energy generator, and preferably comprises a solar and/or a wind energy generator.

19. The installation according to claim 1, which comprises a battery for storage of electrical power.

20. The installation according to claim 1, which comprises a winch, or other winding mechanism.

21. The installation according to claim 1, wherein the radio frequency transceiver comprises a phased array antenna.

22. The installation according to claim 21, wherein the phased array antenna is cylindrical with its central axis vertically oriented, with antenna elements distributed around the cylindrical outer surface.

23. The installation according to claim 22, wherein the ratio of the length to the diameter of the cylinder is greater than 2.0, preferably greater than 5.0.

24. The installation according to claim 23, wherein the antenna elements are composed of multiple antenna elements and a composite element, which are phased together in the analogue domain.

25. The installation according to claim 24, wherein the elements are phased together using fixed amplitude and phase.

26. The installation according to claim 25, wherein the composite elements are arranged in a chequerboard layout, enabling the accommodation of long composite elements.

27. The installation according to claim 1, wherein the ground-based location comprises aerostat monitoring equipment connected to an aerostat control system.

28. The installation according to claim 1, wherein the aerostat is an elongate aerostat that is vertically oriented.

29. The installation according to claim 1, wherein the wider communication network comprises a wireless communications system with conventional towers of less than 30 m in height above ground level.

30. A wireless communication system, comprising a network of a plurality of installations according to claim 1, the installations being linked together by data links, providing a networked wireless communication area.

31. The wireless communication system according to claim 30, wherein the data links between the ground-based locations comprise a radio frequency data link via the transceivers.

32. The wireless communication system according to claim 30, which comprises at least five, preferably at least ten ground-based base stations according to any one of claims 1 to 27, and wherein the networked wireless communication area is greater than 10,000 km², preferably greater than 20,000 km², most preferably greater than 50,000 km².
